(19) United States
(12) Patent Application Publication
(10) Pub. No.: US 2014/0319809 A1
(43) Pub. Date: Oct. 30, 2014

(54) Airbag, In Particular for a Motor Vehicle

(71) Applicants: Ralf Bogenrieder, Stuttgart (DE); Christian Burczyk, Stuttgart (DE); Andreas Hirth, Dielheim (DE); Friedrich Reiter, Sindelfingen (DE)

(72) Inventors: Ralf Bogenrieder, Stuttgart (DE); Christian Burczyk, Stuttgart (DE); Andreas Hirth, Dielheim (DE); Friedrich Reiter, Sindelfingen (DE)

(73) Assignee: Daimler AG, Stuttgart (DE)

(21) Appl. No.: 14/343,481

(22) PCT Filed: Aug. 7, 2012
(86) PCT No.: PCT/EP2012/003364

§ 371 Date: Jun. 9, 2014

(30) Foreign Application Priority Data
Sep. 8, 2011 (DE) 10 2011 112 883.6

(51) Int. Cl. B60R 21/239

(52) U.S. Cl. CPC B60R 21/239; B60R 2021/2395
USPC 280/742

(57) ABSTRACT

An airbag for a motor vehicle includes a support structure having a plurality of hollow body parts. The support structure is moveable from a storage position to a support position by inserting gas into the hollow body parts and by which a support volume of the airbag is at least partially covered in its support position. The airbag also includes at least one overflow opening via which the gas is able to be introduced into the support volume from at least one of the hollow body parts.

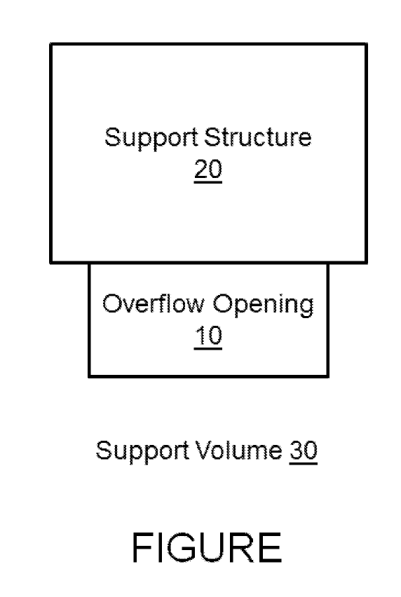

### BACKGROUND OF THE INVENTION

Exemplary embodiments of the invention relate to an airbag for a motor vehicle.

German patent document DE 10 2007 052 246 A1 discloses an airbag for a motor vehicle having a support structure, which is moveable from a storage position to a support position. The airbag comprises a cover, by means of which a support volume of the airbag, formed by the support structure in its support position, is covered.

### SUMMARY OF THE INVENTION

In the case of the airbag of German patent document DE 10 2007 052 246 A1, it is advantageous for the catching and support function of the airbag if a particularly high quantity of gas, in particular air, is received in the support volume. Thus, in the case of an impact force of the motor vehicle caused by an accident, only a very short time span is available to introduce gas or air into the support volume.

Exemplary embodiments of the present invention are directed to an airbag for a motor vehicle that is configured to introduce a particularly high quantity of gas into the support volume in a particularly simple way.

In accordance with exemplary embodiments of the present invention the airbag for a motor vehicle includes a support structure having a plurality of hollow body parts. The support structure is moveable from a storage position to a support position by inserting gas into the hollow body parts and by which a support volume of the airbag is at least partially covered in its support position. The airbag also includes at least one overflow opening via which the gas is able to be introduced into the support volume from at least one of the hollow body parts.

### BRIEF DESCRIPTION OF THE DRAWING FIGURE

The sole figure is a highly schematic illustration of an airbag in accordance with exemplary embodiments of the present invention.

### DETAILED DESCRIPTION

In accordance with exemplary embodiments of the present invention an airbag for a motor vehicle includes a support structure having a plurality of hollow body parts. The support structure is moveable from a storage position to a support position by inserting gas, in particular air, into the hollow body parts. In its supporting position, a support volume of the airbag is at least partially covered by the support structure. To load the hollow body parts with the gas, the airbag comprises, for example, at least one actuator, in particular a gas generator, by means of which the gas is able to be blown into the hollow body parts.

Referring specifically to the sole figure, according to the invention, at least one overflow opening 10 is provided, via which the gas from at least one of the hollow body parts and thus from the support structure 20 can be introduced into the support volume 30. In other words, the gas can flow from the hollow body parts or from the support structure 20 into the support volume 30. It is thus possible to introduce a particularly high quantity of gas, in particular air, into the support volume 30 in only a particularly short period of time. This is advantageous for the support effect of the air bag according to the invention, as, in the case of an impact of at least one passenger of the motor vehicle with the support structure, a relatively high internal pressure prevails as a result of the high quantity of gas in the support volume and a desired higher internal pressure does not have to be built up by the impact of the passenger with the support structure 20, which is referred to as immersion.

Furthermore, the airbag according to the invention has the advantage that the high quantity of gas (gas filling) in the support volume 30 is enabled without an additional actuator, i.e. without an additional gas or energy source, and thus in a particularly simple way. In fact, the at least one actuator that is already provided can be used in order to both move the support structure to the support position and to introduce the gas into the support volume 30, in that the gas can flow out of the support structure 20 and into the support volume 30. The airbag according to the invention thus has a particularly advantageous support function as well as a small number of parts, low costs and a low weight as well as a low installation space requirement, in particular in the support position.

Therein, the overflow opening 10 is, for example, provided in the at least one hollow body part or in the support structure 20 and, on the one hand, flows advantageously directly into the support volume 30 and, on the other, advantageously flows directly into the at least one hollow body part.

The hollow body parts are formed, for example, at least primarily in a tubular manner, i.e. as tube elements and have respective volumes, which are able to be inserted or inflated with the gas, in particular air, and are thus able to increase in volume. Thus the support structure 20 is moved into the support position, i.e. is inflated.

Preferably, the support structure 20 is formed at least primarily in a latticed manner, wherein the hollow body parts function as struts of the lattice, in particular in their design as tube elements. Advantageously, the hollow body parts are at least partially fluidically connected to one another. Preferably, all hollow body parts are connected fluidically to one another. A connected total volume is formed by the fluidic connection of the hollow body parts, the total volume being able to be loaded with the gas, in particular air, to move the support structure 20 from the storage position to the support position.

This total volume, which is to be actively loaded with the gas by means of the at least one actuator, is therein primarily smaller than the support volume 30, which is stretched in the support position by the support structure 20. Thus, the support structure 20 can be moved to the support position in a particularly short time period, i.e. particularly quickly and smoothly for the passengers to be caught and supported, and can then take on a particularly large volume in a passenger space of the motor vehicle. Thus, the passenger can be caught, in particular, early on in the case of a force impact due to an accident and thus can be protected from severe injuries.

Between the hollow body parts of the support structure formed as a lattice structure, free surfaces or free spaces are formed, via which ambient air can flow passively into the support volume from the passenger space. In the case of the movement of the support structure from the storage position to the support position, a vacuum first occurs in the support volume, such that, in the storage position (unfolding), ambient air is sucked into the support volume from the passenger space during the movement of the support structure. Therein the filling of the support volume occurs passively, as opposed to the active insertion of the hollow body parts by means of the at least one actuator.

In order to provide a particularly high gas quantity or air quantity in the storage volume, gas, in particular air, can additionally flow into the support volume 30 from the support structure 20 or from the hollow body parts via the at least one overflow opening 10.

The airbag preferably comprises a cover, by means of which the support volume is at least partially covered. Therein, the cover is at least partially formed as a valve unit or a valve unit is integrated into the cover. Therein, the valve unit has a valve functionality, such that the ambient air can flow into the support volume in a first flow direction with a first particularly high mass flow. It can be provided that the valve unit prevents the air located in the support volume from flowing out of the support volume in a second flow direction that is opposed to the first flow direction.

Alternatively it can be provided that the valve unit allows the air situated in the support volume to flow out in the second flow direction in a manner that is only restricted with regard to the in-flow in the first flow direction. In other words, the air can then flow out of the support volume with a lower mass flow than it can or could flow into the support volume. Thus, a long service life of the airbag is achieved, such that the support structure, and with this the cover, can be moved to the support position in particularly good time or before the force impact due to an accident and the passengers can be caught supported efficiently.

The gas or air quantity received in the support volume plays a relatively important role in the support effect of the airbag. If a relatively low quantity of gas or air is received in the support volume, which is referred to as a low pressure part of the airbag, then a desired higher excess pressure only then results if the passenger is immersed in the airbag, i.e. hits the support structure and in particular the cover. This undesired late occurrence of the desired high internal pressure in the support volume can now be prevented with the airbag according to the invention, as the support volume can be filled with a particularly high air or gas quantity via the overflow opening. Thus the desired high internal pressure is then at least primarily already available in the support volume if the passenger is immersed in the airbag.

The object of the support structure 20 is, in particular, to unfold or deploy the air bag by means of its active filling with gas, in particular air, and thus also to form the support volume 30. The support structure 20 is of less significance for the support effect of the airbag after the support volume 30 spreads out. It therefore occurs that the desired bearing effect of the support structure 20 is only of relatively greater significance in the unfolding phase, i.e. in the movement phase of the support structure 20 from the storage position to the support position. If the airbag or the support structure 20 first unfolds and the passenger begins to be immersed in the airbag, then it is no longer necessarily required to sustain the excess pressure in the hollow body parts to unfold the support structure 20. This is the case, as the support and catching effect is provided after the movement into the support position, in particular by the support volume and if necessary the cover covering the support volume.

Thus, the gas, in particular the air, can be channeled from or out of the support structure 20, which is referred to as a high pressure part, and introduced into the support volume (low pressure part) 30 and can overflow, in order to depict a particularly high filling of the support volume 30 with gas or air. This is particularly advantageous for the support effect of the airbag.

The overflow opening 10 is, for example, formed as a passage opening, in particular as a punched hole, of the support structure or of the at least one hollow body part. Preferably the overflow opening 10 is arranged such that the overflow opening 10 is first covered in the storage position, i.e. at least primarily fluidically blocked. To this end, the overflow opening is, for example, covered by the support structure. Advantageously, the overflow opening 10 is only then fluidically released from its folded state in the storage position into the support position towards the end of the movement procedure, in particular of the unfolding procedure, of the support structure, such that it releases the path of the gas from the high pressure part to the low pressure part.

Likewise, a valve element can be provided, by means of which the overflow opening 10 is able to be released and is able to be at least primarily fluidically closed. To this end, the valve element is, for example, able to move between a closed position, which closes the overflow opening 10 fluidically, and an open position, which releases the overflow opening 10 at least partially.

The valve element can, for example, be formed as a textile, in particular as a fabric, or as a film and can be held onto the support structure. Therein, the film is formed, for example, from a plastic that is at least primarily permeable for gas or air.

In an advantageous embodiment of the invention, the valve element is able to be switched from the closed position into the open position automatically in the case of a given difference of pressures in the support volume 30 and in the at least one hollow body part. In other words, the valve element only opens in the case of a given pressure in the at least one hollow body part or in the support structure 20, such that the gas can only overflow into the low pressure part from the high pressure part in the case of achieving the given pressure.

The valve element can, for example, also be formed as an inner tube valve, which then only turns upside down if the inner tube valve has a corresponding freedom of movement which enables it to turn upside down. This freedom of movement is, for example, achieved from a certain position of the support structure 20 during its movement from the storage position to the support position, such that the overflow position is released from this position and the gas can overflow from the support structure 20 into the support volume 30.

The valve element can also be an active valve which can be switched between the closed position and the open position, which, for example, is able to be switched electrically, pneumatically and/or hydraulically by means of at least one actuator allocated to the valve element. Thus the overflow opening can be released or closed particularly according to need.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-5. (canceled)

6. An airbag for a motor vehicle, comprising:
a support structure having a plurality of hollow body parts, wherein the support structure is moveable from a storage position to a support position by providing gas into the hollow body parts, and wherein a support volume of the airbag is at least partially covered in its support position; and
at least one overflow opening configured so that gas flows form at least one of the hollow body parts into the support volume.

7. The airbag of claim 6, further comprising:
at least one valve element configured so that the overflow opening is openable and closeable.

8. The airbag of claim 7, wherein the valve element is automatically switchable from a closed position that closes the overflow opening to an open position that at least partially releases the overflow opening due to difference in pressures in the support volume and in the at least one hollow body part.

9. The airbag of claim 7, further comprising:
an actuator configured to adjust the valve element from a closed position that closes the overflow opening to an open position that at least partially releases the overflow opening.

10. The airbag of claim 7, wherein the valve element is formed of a fabric or a plastic film.
